(19) United States
(12) Patent Application Publication
(10) Pub. No.: US 2022/0106798 A1
(43) Pub. Date: Apr. 7, 2022

(54) Scaffold-Attachable Storage Device

(71) Applicant: Joseph Johnson, Avondale, AZ (US)

(72) Inventor: Joseph Johnson, Avondale, AZ (US)

(21) Appl. No.: 17/496,362

(22) Filed: Oct. 7, 2021

Related U.S. Application Data
(60) Provisional application No. 63/088,489, filed on Oct. 7, 2020.

(51) Int. Cl. E04G 5/00; A45F 3/04; H01R 25/00

(52) U.S. Cl. CPC E04G 5/003; A45F 2003/003; H01R 25/006; A45F 3/04

(57) ABSTRACT

The present invention relates to a scaffold-attachable storage device primarily comprised of a top surface with a continuous opening, a pair of generally parallel side surfaces with at least one pocket, a bottom surface further comprised of at least one hammer ring, a front surface further comprised of at least one hook, at least one power outlet, at least one pocket and a rear surface with at least one hook. The body is preferably transparent and may be manufactured from a durable metal, a fabric or a plastic material. The pockets, hooks and rings of the device allow a user to store and/or hang a plurality of tools within and on the body. Further, the device is comprised of at least one hook that allows the device to be easily hung from a scaffolding railing, such that it does not obstruct the walkway of a scaffolding.

### CROSS-REFERENCE TO RELATED APPLICATION

The present application claims priority to, and the benefit of, U.S. Provisional Application No. 63/088,489, which was filed on Oct. 7, 2020 and is incorporated herein by reference in its entirety.

### FIELD OF THE INVENTION

The present invention relates generally to the field of tool storage. More specifically, the present invention relates to a scaffold-attachable storage device primarily comprised of a top surface with a continuous opening, a pair of generally parallel side surfaces with at least one pocket, a bottom surface further comprised of at least one hammer ring, a front surface further comprised of at least one hook, at least one power outlet, at least one pocket and a rear surface with at least one hook. The body is preferably generally rectangular in shape and the pockets, hooks and rings of the device allow a user to store and/or hang a plurality of tools within and on the body of the device. Accordingly, the present disclosure makes specific reference thereto. Nonetheless, it is to be appreciated that aspects of the present invention are also equally applicable to other like applications, devices and methods of manufacture.

### BACKGROUND

Individuals in the construction industry frequently use scaffolds while working high up on various structures or surfaces. While working, said individuals also frequently use a plurality of tools. These tools must then be stored on a tool belt of the individual or on the scaffolding itself. However, an individual may need to possess such a large number of tools, that all tools cannot be easily worn on a tool belt. In this manner, an individual may choose to keep some tools on the ground. This is undesirable however, as the individual must then climb up/down the scaffolding to retrieve tools as needed, which is inefficient and time-consuming. As a result, an individual may choose to leave the tools on the scaffolding walkway. However, this is also undesirable and even dangerous, as the tools may create a tripping hazard, such that the individual may trip and fall off the scaffolding, which can result in serious injury and even death. Further, the tools may fall off the scaffolding, such that they can seriously injure individuals underneath the scaffolding or on other scaffolding levels. In addition, if an individual elects to keep tools on a scaffolding, the tools are often stored in a dis-organized manner.

Therefore, there exists a long-felt need in the art for a device that allows a user to store a plurality of tools on a scaffolding. There also exists a long-felt need in the art for a scaffold-attachable storage device that allows a user to store a plurality of tools on a scaffolding, but prevents the tools from falling off the scaffolding and also prevents the tools from being a tripping hazard. Further, there exists a long-felt need in the art for a scaffold-attachable storage device that can be easily attached to a scaffold and allows a plurality of tools to remain stored in an organized and easily accessible fashion.

The subject matter disclosed and claimed herein, in one embodiment thereof, comprises a scaffold-attachable storage device. The device is primarily comprised of a top surface with a continuous opening, a pair of generally parallel side surfaces with at least one pocket, a bottom surface further comprised of at least one hammer ring, a front surface further comprised of at least one hook, at least one power outlet, at least one pocket and a rear surface with at least one hook. The body is preferably generally rectangular in shape and is rigid and transparent. The body may further be manufactured from a durable metal, a fabric or a plastic material. The pockets, hooks and rings of the device allow a user to store and/or hang a plurality of tools within and on the body of the device. Further, the device is comprised of at least one hook that allows the device to be easily hung from a scaffolding railing, such that it does not obstruct the walkway of a scaffolding.

In this manner, the scaffold-attachable storage device of the present invention accomplishes all of the forgoing objectives and allows a user to store a plurality of tools on a scaffolding. However, the device prevents the tools from falling off the scaffolding, and also prevents the tools from being a tripping hazard. Furthermore, the device can be easily and securely attached to a scaffold. The device also allows a plurality of tools to remain stored in an organized and easily accessible fashion within the device. As a result, the scaffold-attachable storage device overcomes the limitations of existing methods of storing tools on scaffoldings known in the art, and provides a safe means to store tools on a scaffolding.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scaffold-attachable storage device primarily comprised of a body, further comprised of a top surface with a continuous opening, a pair of generally parallel side surfaces with at least one pocket, a bottom surface further comprised of at least one hammer ring, a front surface further comprised of at least one hook, at least one power outlet, at least one pocket and a rear surface with at least one hook. The body is preferably generally rectangular in shape and is rigid and transparent. The body may further be manufactured from a durable metal, a fabric or a plastic material.

To allow the device to be easily carried up and down scaffolding, the top surface and/or side surfaces are further comprised of at least one handle, and the rear surface may be comprised of at least one shoulder strap that allows the device to be carried on the back of a user. The top surface also has at least one continuous opening that allows a user to store a plurality of tools within the body, wherein the transparency of the body further allows a user to easily and quickly locate any tool stored within the body. The continuous opening may be covered by a lid that further has its own handle and is connected to the top surface via at least one hinge. In one embodiment, the lid can also be secured via at least one fastener that allows the lid to be secured in a closed position.

The side surfaces and front surface are further comprised of at least one pocket that is preferably transparent and can be also used to store tools. The pocket may further be comprised of a lid that can be secured via at least one fastener, that allows the pocket to be secured in a closed position. The fastener may be comprised of at least one lock and/or any fastener known in the art. The bottom surface is further preferably comprised of at least one hammer ring that can receive a hammer or other tool of the like. The front surface is further comprised of at least one hook that allows a user to easily hang a nail gun or other similar tool. In order to power various tools, the front surface is also comprised of at least one power outlet that allows the male plug of any conventional tool known in the art to be plugged into the outlet and receive power. The outlet further receives power from a power cord that can be plugged into a nearby outlet, that is preferably located near the scaffolding the device is attached to.

The rear surface of the body is further comprised of at least one hook that can be hung on the railing of a scaffolding to allow the device to be hung from the railing. In this manner, the device and any tools hung from or stored in the device does not obstruct the walkway of the scaffolding. It should be appreciated that the device can be hung using the hook to any structure known in the art beyond a scaffolding railing, such as but not limited to, a ladder, a wall, a roof, a pole, etc. In order to ensure the hook remains attached around a railing, the hook may further be comprised of a locking bar that can be locked around the railing and to the rear surface via a lock.

Accordingly, the scaffold-attachable storage device of the present invention is particularly advantageous, as it allows a user to store a plurality of tools on a scaffolding but prevents the tools from falling off the scaffolding. The device also prevents the tools from being a tripping hazard. Further, the device can be easily and securely attached to a scaffold and allows a plurality of tools to remain stored in an organized and easily accessible fashion within the device. In this manner, the scaffold-attachable storage device overcomes the limitations of existing methods of storing tools on scaffoldings known in the art, and allows a user to safely store tools on a scaffolding.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the scaffold-attachable storage device of the present invention in accordance with the disclosed architecture;

FIG. 2 illustrates a perspective view of one potential embodiment of the scaffold-attachable storage device of the present invention in use while attached to a scaffolding in accordance with the disclosed architecture;

FIG. 3 illustrates a top perspective view of one potential embodiment of the scaffold-attachable storage device of the present invention displaying the continuous opening in accordance with the disclosed architecture;

FIG. 4 illustrates a perspective view of one potential embodiment of the scaffold-attachable storage device of the present invention displaying the top handle in accordance with the disclosed architecture;

FIG. 5 illustrates a perspective view of one potential embodiment of the scaffold-attachable storage device of the present invention displaying the front tray and indicia in accordance with the disclosed architecture;

FIG. 6 illustrates a perspective view of one potential embodiment of the scaffold-attachable storage device of the present invention displaying the hammer ring in accordance with the disclosed architecture; and

FIG. 7 illustrates a front perspective view of one potential embodiment of the scaffold-attachable storage device of the present invention displaying the front hooks in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a user to store a plurality of tools on a scaffolding. There also exists a long-felt need in the art for a scaffold-attachable storage device that allows a user to store a plurality of tools on a scaffolding that prevents the tools from falling off the scaffolding, and also prevents the tools from creating a tripping hazard. Further, there exists a long-felt need in the art for a scaffold-attachable storage device that can be easily attached to a scaffold, and allows a plurality of tools to remain stored in an organized and easily accessible fashion.

The present invention, in one exemplary embodiment, is comprised of a scaffold-attachable storage device primarily comprised of a body further comprised of a top surface with a continuous opening, a pair of generally parallel side surfaces with at least one pocket, a bottom surface further comprised of at least one hammer ring, a front surface further comprised of at least one hook, at least one power outlet, at least one pocket and a rear surface with at least one hook. The body is preferably generally rectangular in shape and is also preferably rigid and transparent. The body is also manufactured from a durable metal, a fabric and/or a plastic material.

To allow the device to be easily carried up and down scaffolding, the top surface and/or side surfaces are further comprised of at least one handle, and the rear surface may be comprised of at least one shoulder strap that allows the device to be carried on the back of a user. The top surface also has at least one continuous opening that allows a user to store a plurality of tools within the body. The transparency of the body further allows a user to easily and quickly locate any tool stored within the body. The opening may be covered by a lid that further has its own handle and is connected to the top surface via at least one hinge. The lid can also be secured via at least one fastener that allows the lid to be secured in a closed position.

The side surfaces and front surface are further comprised of at least one pocket that is preferably transparent and can also be used to store tools. The pocket may further be comprised of a lid that can be secured via at least one fastener that allows the pocket to be secured in a closed position. The fastener may be comprised of at least one lock and/or any suitable fastener as is known in the art. The bottom surface is further preferably comprised of at least one hammer ring that can receive a hammer or other suitable tool. The front surface is further comprised of at least one hook that allows a user to easily hang a nail gun or other suitable tool. In order to power various tools, the front surface is also comprised of at least one power outlet that allows the male plug of any conventional tool known in the art to be plugged into the outlet and receive power. The outlet further receives power from a power cord that can be plugged into a nearby outlet, that is preferably located near the scaffolding.

The rear surface of the body is further comprised of at least one hook that can be hung on the railing of a scaffolding to allow the device to be hung from the railing, such that the device does not obstruct the walkway of the scaffolding. It should be appreciated that the device can be hung using the hook to any suitable structure known in the art besides a scaffolding railing such as, but not limited to, a ladder, a wall, a roof, a pole, etc. In order to ensure the hook remains attached around a railing, the hook may further be comprised of a locking bar that can be locked around the railing and to the rear surface via a lock.

Accordingly, the scaffold-attachable storage device of the present invention is particularly advantageous, as it allows a user to store a plurality of tools on a scaffolding. However, the device prevents the tools from falling off the scaffolding, and also prevents the tools from being a tripping hazard. Further, the device can be easily and securely attached to a scaffold. The device also allows a plurality of tools to remain stored in an organized and easily accessible fashion within the device. In this manner, the scaffold-attachable storage device overcomes the limitations of existing methods of storing tools on scaffoldings known in the art, and allows a user to safely store tools on a scaffold in an organized manner.

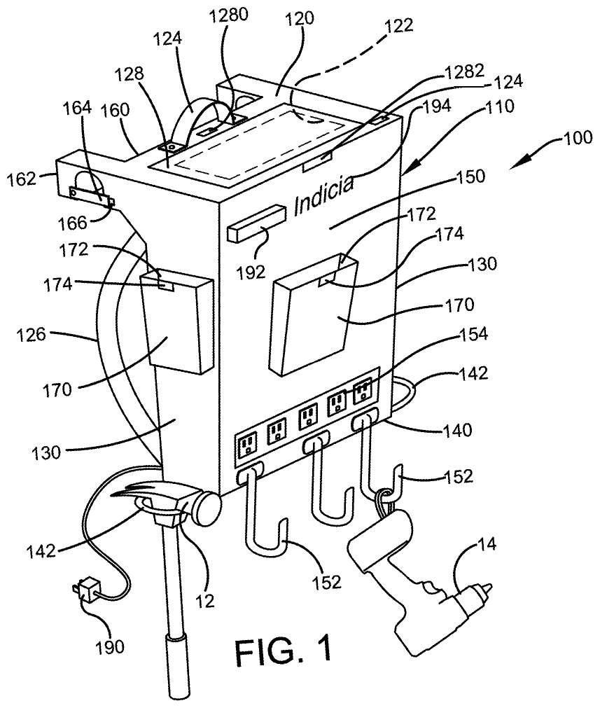

Referring initially to the drawings, FIG. 1 illustrates a perspective view of one embodiment of the scaffold-attachable storage device 100 of the present invention. The device 100 is primarily comprised of a body 110, further comprised of a top surface 120 with a continuous opening 122, a pair of generally parallel side surfaces 130 with at least one pocket 170, a bottom surface 140 further comprised of at least one hammer ring 142, a front surface 150 further comprised of at least one hook 152, at least one power outlet 154, at least one pocket 170 and a rear surface 160 with at least one hook 162. The body 110 is further preferably generally rectangular in shape, but may be any suitable shape as is known in the art such as, but not limited to, a square, circular, triangular, oblong, etc. In a preferred embodiment, the body 110 is rigid, but may also be flexible or semi-rigid in differing embodiments. Further, the body 110 is also preferably transparent, but may be semi-transparent or opaque as well. The body 110 may be manufactured from a durable metal, such as but not limited to, stainless steel or aluminum, etc., or a durable fabric such as, but not limited to, a vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. However, the body 110 is preferably comprised of a plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable material as is known in the art. In addition, the body 110 may be comprised of any combination of metal, fabric and/or plastic as is known in the art.

To allow the device 100 to be easily carried up and down scaffolding, the top surface 120 and/or side surfaces 130 are further comprised of at least one handle 124, which is any suitable handle as is known in the art that allows a user to carry the device 100. In addition, the rear surface 160 may be comprised of at least one shoulder strap 126 that allows the device 100 to be carried on the back of a user similar to a backpack. Typically, there are two shoulder straps 126 which allow a user to easily carry the device on his or her back, but any suitable number of shoulder straps 126 can be used, based on how heavy the device is and how many tools a user wishes to carry within the device 100.

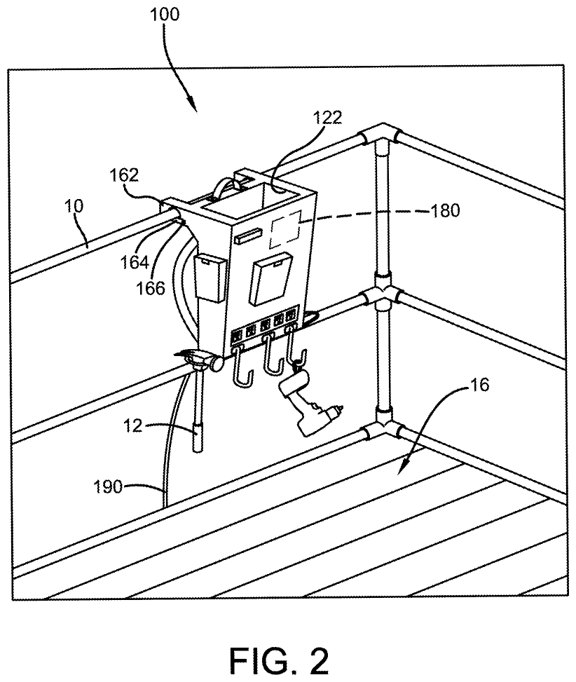

The top surface 120 is further comprised of at least one continuous opening 122 that allows a user to store a plurality of tools (not shown) within the body 110, wherein the body 110 is preferably hollow and has an easily accessible cavity. The transparency of the body 110 further allows a user to easily and quickly locate any tool stored within the body 110. On one embodiment, the entire body 110 is transparent, whereas in other embodiments, only a portion 180 (shown in FIG. 2) of the body 110 is transparent, allowing a user to look into the cavity to see what tools are in the body 110 without opening the lid 128. Further, in another embodiment, the opening 122 may be covered or secured by a lid 128 that has its own handle 124, wherein the lid 128 is connected to the top surface 120 via at least one hinge 1280. In differing embodiments, the hinge 1280 may be any suitable hinge known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

In one embodiment, the lid 128 can be secured shut via at least one fastener 1282 that allows the lid 128 to be secured in a closed position. In differing embodiments, the fastener 1282 may be comprised of at least one lock such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID keyfob lock, a Bluetooth lock that unlocks via a smart device mobile application, a mechanical dial lock, a numerical combination lock, a pedestal lock, a draw lock, a fixed-core lock, etc., or any other suitable lock as is known in the art to further secure the contents of the opening 122. Further, the fastener 1282 may be any suitable fastener known in the art such as, but not limited to, a hook and loop, snap-button, magnetic, adhesive, button and loop, zipper assembly, etc., to secure the lid 128 shut.

The side surfaces 130 and front surface 150 are preferably comprised of at least one pocket 170, wherein the pocket 170 is preferably transparent and can be also used to store tools. The entire pocket 170 can be transparent, or just portions of the pocket 170 can be transparent, such that a user can identify the pocket's contents without removing the lid 172. In one embodiment, the pocket 170 may further be comprised of a lid 172 that can be secured via at least one fastener 174, that allows the pocket 170 to be secured closed. In differing embodiments, the fastener 174 may be comprised of at least one lock such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID keyfob lock, a Bluetooth lock that unlocks via a smart device mobile application, a mechanical dial lock, a numerical combination lock, a pedestal lock, a draw lock, a fixed-core lock, etc. Further, the fastener 174 may be any suitable fastener as is known in the art such as, but not limited to, a hook and loop, snap-button, magnetic, adhesive, button and loop, zipper assembly, etc.

In addition, the bottom surface 140 is further preferably comprised of at least one hammer ring 142 that can receive a hammer 12 (shown as prior art) or other suitable tool. In lieu of or in addition to a pocket 170, the side surfaces 130 and the front surface 150 may further be comprised of a tray 192, that may or may not be magnetic, for retaining smaller tools and/or fasteners, or any other suitable object as is known in the art.

The front surface 150 is further comprised of at least one hook 152. The hook 152 allows a user to easily hang a nail gun 14 (shown as prior art) or other suitable tool, and can be any suitable hook as is known in the art. In order to power various tools, the front surface 150 is also comprised of at least one power outlet 154. The 120V/240V outlet 154 allows the male plug of any conventional tool known in the art to be plugged into the outlet 154 and receive power. The outlet 154 further receives power from a power cord 190 that can be plugged into a nearby outlet, that is preferably located near the scaffolding the device 100 to which it is attached. In another embodiment of the present invention, the device 100 is powered by Lithium-Ion batteries. Instead of a conventional wall outlet, a Lithium-Ion battery is used to power the power outlets 154 on the device 100.

FIG. 2 illustrates a perspective view of one embodiment of the scaffold-attachable storage device 100 of the present invention in use while attached to a scaffolding 10 (shown as prior art). The rear surface 160 of the body 110 is further comprised of at least one hook 162. The hook 162 can be hung on the railing 10 of a scaffolding to allow the device 100 to be hung from the railing 10 at whatever position along the scaffolding the user desires. In this manner, the device 100 does not obstruct the walkway 16 of the scaffolding. It should be appreciated that the device 100 can be hung using the hook 162 to any suitable structure known in the art besides a scaffolding railing 10, such as but not limited to, a ladder, a wall, a roof, a piece of wood/metal, a pole, etc. In order to ensure the hook 162 remains attached around a railing 10 when desired, the hook 162 may further be comprised of a hinged locking bar 164 that can be locked around the railing 10 and to the rear surface 160. In differing embodiments, the locking bar 164 may be comprised of a lock 166 such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID keyfob lock, a Bluetooth lock that unlocks via a smart device mobile application, a mechanical dial lock, a numerical combination lock, a pedestal lock, a draw lock, a fixed-core lock, etc., wherein the lock 166 locks the bar 164 to the rear surface 160, once the bar 164 has been placed around a railing 10, after the railing 10 has been received by the hook 162.

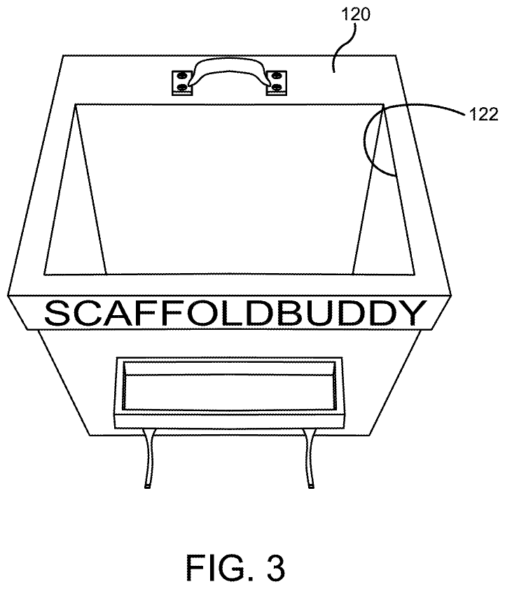

FIG. 3 illustrates a top perspective view of the scaffold-attachable storage device 100 of the present invention. The top surface 120 is further comprised of at least one continuous opening 122 that allows a user to store a plurality of tools (not shown) within the body 110, wherein the body 110 is preferably hollow and has an easily accessible cavity. In one embodiment, the entire body 110 is transparent, whereas in other embodiments, only a portion 180 (shown in FIG. 2) of the body 110 is transparent, allowing a user to look into the cavity to see what tools are in the body 110 without opening the lid 128.

Further, in another embodiment, the opening 122 may be covered or secured by a lid 128 that has its own handle 124, wherein the lid 128 is connected to the top surface 120 via at least one hinge 1280. In differing embodiments, the hinge 1280 may be any suitable hinge known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

In another embodiment, the lid 128 can be secured shut via at least one fastener 1282 that allows the lid 128 to be secured in a closed position. In differing embodiments, the fastener 1282 may be comprised of at least one lock such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed-core lock, etc., or any other suitable lock as is known in the art to further secure the contents of the opening 122. Further, the fastener 1282 may be any suitable fastener known in the art such as, but not limited to, a hook and loop, snap-button, magnetic, adhesive, button and loop, zipper assembly, etc., to secure the lid 128 shut.

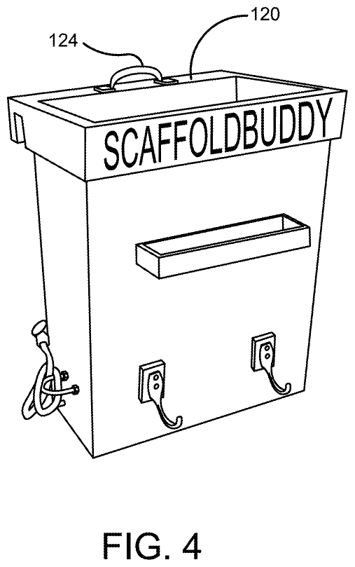

FIG. 4 illustrates a perspective view of the scaffold-attachable storage device 100 of the present invention. To allow the device 100 to be easily carried up and down scaffolding, the top surface 120 and/or side surfaces 130 are further comprised of at least one handle 124, which is any suitable handle as is known in the art that allows a user to carry the device 100. Typically, the handle 124 is manufactured of metal, but can be of any suitable material as is known in the art.

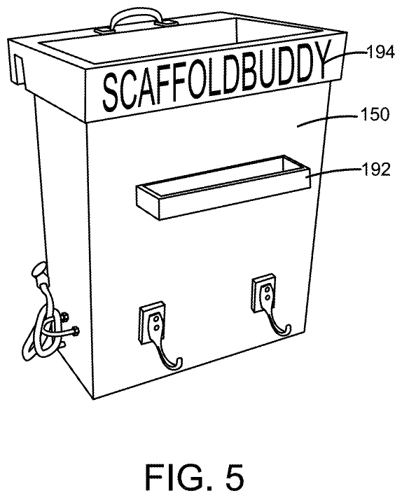

FIG. 5 illustrates a perspective view of the scaffold-attachable storage device 100 of the present invention. In lieu of or in addition to a pocket 170, the side surfaces 130 and the front surface 150 may comprise a tray 192, that may or may not be magnetic, for retaining smaller tools and/or fasteners, or any other suitable object as is known in the art. Furthermore, all surfaces 120, 130, 140, 150, 160 and/or components may be comprised of a plurality of indicia 194, such as but not limited to: patterns, logos, emblems, images, symbols, designs, letters, words, characters, animals, advertisements, brands, etc., or any other suitable indicia as is known in the art.

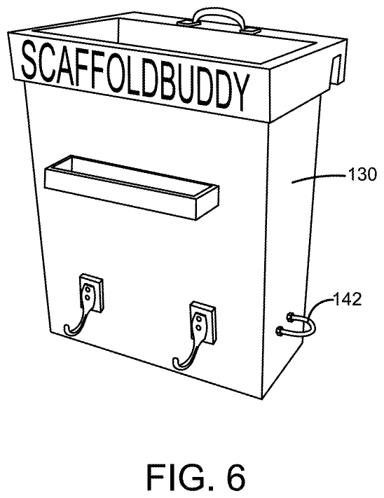

FIG. 6 illustrates a perspective view of the scaffold-attachable storage device 100 of the present invention. In addition, the bottom surface 140 is further preferably comprised of at least one hammer ring 142 that can receive a hammer (not shown) or other suitable tool. Any number of hammer rings 142 can be utilized on any surface of the device 100, depending on the wants and/or needs of a user. Preferably, the hammer rings 142 can be manufactured of metal, but can also be manufactured of any suitable material as is known in the art.

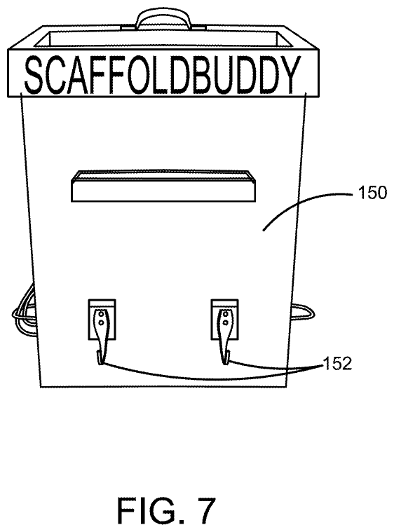

FIG. 7 illustrates a front perspective view of the scaffold-attachable storage device 100 of the present invention. The front surface 150 is further comprised of at least one hook 152. The hook 152 allows a user to easily hang a nail gun (not shown) or other suitable tool, and can be any suitable hook as is known in the art. Any number of hooks 152 can be utilized on any surface of the device 100, depending on the wants and/or needs of a user. Preferably, the hooks 152 can be manufactured of metal, but can also be manufactured of any suitable material as is known in the art.

It should be further appreciated that any feature of any surface 120, 130, 140, 150, 160 disclosed supra may be found on any additional or alternative surface 120, 130, 140, 150, 160 of the body 110. In addition, not all features disclosed as being part of or located on any surface 120, 130, 140, 150, 160 must be present on said surfaces 120, 130, 140, 150, 160 in every embodiment of the device 100. In this manner, embodiments of the device 100 may exists with surfaces 120, 130, 140, 150, 160 that lack the features described as being located or are part of said surfaces 120, 130, 140, 150, 160 supra. Further, all surfaces 120, 130, 140, 150, 160 and/or components may be comprised of a plurality of indicia 194 such as, but not limited to, patterns, logos, emblems, images, symbols, designs, letters, words, characters, animals, advertisements, brands, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “scaffold-attachable storage device” and “device” are interchangeable and refer to the scaffold-attachable storage device 100 of the present invention.

Notwithstanding the forgoing, the scaffold-attachable storage device 100 of the present invention and its various components can be of any suitable size and configuration as is known in the art without affecting the overall concept of the invention, provided that they accomplish the above-stated objectives. One of ordinary skill in the art will appreciate that the size, configuration and material of the scaffold-attachable storage device 100 as shown in FIGS. 1-2 is for illustrative purposes only, and that many other sizes and shapes of the scaffold-attachable storage device 100 are well within the scope of the present disclosure. Although the dimensions of the scaffold-attachable storage device 100 are important design parameters for user convenience, the scaffold-attachable storage device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A scaffold-attachable storage device that allows a user to store a plurality of tools on a scaffolding without obstructing a walkway of the scaffolding, the scaffold-attachable device comprising:
a body comprising a rear surface, a front surface, a top surface, a bottom surface, and a set of generally parallel side surfaces;
wherein the rear surface comprises at least one hook;
wherein the front surface comprises at least one hook, at least one power outlet, and at least one pocket;
wherein the at least one power outlet is powered via a power cord that is plugged into a nearby outlet located near the scaffolding;
wherein the top surface comprises a continuous opening;
wherein the bottom surface comprises at least one hammer ring; and
wherein the set of generally parallel side surfaces comprise at least one pocket.

2. The scaffold-attachable storage device of claim 1, wherein the scaffold-attachable storage device can be hung from a scaffolding railing by the at least one hook of the rear surface, such that the scaffold-attachable storage device does not obstruct the walkway of the scaffolding.

3. The scaffold-attachable storage device of claim 1, wherein a plurality of tools can be stored within the body.

4. The scaffold-attachable storage device of claim 1, wherein at least one tool can be hung on the at least one hammer ring or the at least one hook of the front surface.

5. A scaffold-attachable storage device that allows a user to store a plurality of tools on a scaffolding without obstructing a walkway of the scaffolding, the scaffold-attachable storage device comprising:
a transparent body that stores a plurality of tools, the transparent body comprising a rear surface, a front surface, a top surface, a bottom surface, and a set of generally parallel side surfaces;
wherein the rear surface comprises at least one hook;
wherein the front surface comprises at least one hook for storing at least one tool, at least one power outlet, and at least one pocket for storing at least one tool;
wherein the at least one power outlet is powered via a power cord that is plugged into a nearby outlet located near the scaffolding;
wherein the top surface comprises a handle and a continuous opening;
wherein the bottom surface comprises at least one hammer ring for retaining at least one hammer; and
wherein the set of generally parallel side surfaces comprise at least one transparent pocket that receives a tool.

6. The scaffold-attachable storage device of claim 5, wherein the scaffold-attachable storage device can be hung from a scaffolding railing by the at least one hook of the rear surface, such that the scaffold-attachable storage device does not obstruct the walkway of the scaffolding.

7. The scaffold-attachable storage device of claim 5, wherein the transparent body is comprised of a plastic material.

8. The scaffold-attachable storage device of claim 5, wherein the scaffold-attachable storage device can be hung from a ladder, a wall, a roof, a piece of wood or a piece of metal or a pole.

9. A scaffold-attachable storage device that allows a user to store a plurality of tools on a scaffolding without obstructing a walkway of the scaffolding, the scaffold-attachable storage device comprising:
a hollow body that stores a plurality of tools, comprising a rear surface, a front surface, a top surface, a bottom surface, and a set of generally parallel side surfaces;
wherein the rear surface comprises at least one hook, a hinged-locking bar, a lock that allows the scaffold-attachable storage device to be hung around a scaffolding railing, and at least one shoulder strap;
wherein the front surface comprises at least one hook for storing at least one tool, at least one power outlet, and at least one transparent pocket for storing at least one tool;
wherein the at least one power outlet is powered via a power cord that is plugged into a nearby outlet located near the scaffolding;
wherein the top surface comprises a handle, a continuous opening, and a lid that attaches to a top surface via at least one hinge;
wherein the bottom surface comprises at least one hammer ring for retaining at least one hammer; and
wherein the set of generally parallel side surfaces comprise at least one transparent pocket that receives a tool.

10. The scaffold-attachable storage device of claim 9, wherein at least a portion of the hollow body is comprised of a transparent material.

11. The scaffold-attachable storage device of claim 9, wherein the lid can be secured to the top surface via at least one fastener, such as a lock and/or a hook and loop fastener, a snap-button fastener, a magnetic fastener, an adhesive fastener, a button and loop fastener, and a zipper assembly fastener.

12. The scaffold-attachable storage device of claim 9, wherein the at least one pockets are comprised of a lid that can be secured in a closed position via at least one fastener.

13. The scaffold-attachable storage device of claim 13, wherein the at least one fastener is a lock and/or a hook and loop fastener, a snap-button fastener, a magnetic fastener, an adhesive fastener, a button and loop fastener, and a zipper assembly fastener.

14. The scaffold-attachable storage device of claim 9, wherein the at least one power outlet allows a male plug to be plugged into the at least one power outlet and receive power.

15. The scaffold-attachable storage device of claim 15, wherein the at least one power outlet receives power from the power cord which can be plugged into a nearby outlet.

16. The scaffold-attachable storage device of claim 15, wherein the at least one power outlet receives power from a battery.

17. The scaffold-attachable storage device of claim 9, wherein the scaffold-attachable storage device can be hung from a scaffolding railing, such that is does not obstruct a walkway of a scaffolding.

18. The scaffold-attachable storage device of claim 9, wherein after the at least one hook is positioned around a scaffolding railing and the locking bar can be placed under the railing towards the rear surface.

19. The scaffold-attachable storage device of claim 18, wherein the lock allows the locking bar to lock at the rear surface, such that the scaffolding railing is secured to the hook.

20. The scaffold-attachable storage device of claim 9, wherein the at least one shoulder strap allows the scaffold-attachable storage device to be carried on a user's back, similar to a backpack.
